(19) United States
(12) Patent Application Publication
(10) Pub. No.: US 2003/0226986 A1
(43) Pub. Date: Dec. 11, 2003

(54) Pin with a discharging device

(76) Inventor: Hsi-Kung Yang, Taipei Hsien (TW)

Correspondence Address: VENABLE, BAETJER, HOWARD AND CIVILETTI, LLP, P.O. BOX 34385, WASHINGTON, DC, 20043-9998, US

(21) Appl. No.: 10/166,373

(22) Filed: Jun. 11, 2002

(51) Int. Cl. F16K 31/44

(52) U.S. Cl. 251/82

(57) ABSTRACT

A pin has a hollow body, an extension formed with the hollow body and provided with a passage defined to communicate with an interior of the hollow body and a sphere movably received in the hollow body. The hollow body is divided into a chamber to movably receive therein the sphere and a path by a step. The chamber has a diameter larger than that of the path so that the sphere selectively stops communication between the chamber and the path. The chamber has two elongated bosses oppositely formed on a bottom face defining the chamber and being apart from each other by the passage. An activating rod is integrally formed on the sphere and extends out of the path to so as to move the sphere inside the chamber.

### BACKGROUND OF THE INVENTION

1. Field of the Invention

The present invention relates to a pin for balls, and more particularly to a pin which has a discharging device received therein so that not only can the pin be used as a medium to pump air into a container, but also be used to discharge air from the container.

2. Description of Related Art

A conventional pin for inflatables, such as balls, inner tires and the like is shown in FIG. 5. The pin has a hollow cylindrical body (5), an extension (50) formed on one end of the cylindrical body (5) and having an air path (500) defined to communicate an interior of the hollow cylindrical body (5) and a unidirectional mechanism (6) detachably and threadingly connected to the cylindrical body (5).

The cylindrical body (5) defines therein a passage (51) and has an inner threading (52) formed on an inner periphery defining the passage (51).

The unidirectional mechanism (6) has a path (61) defined to correspond to the passage (51) of the cylindrical body (5), a ball (62) slidably received in the path (61) so as to be positioned at either openings (63,64) of the path (61) and an outer threading (65) corresponding to the inner threading (52) of the cylindrical body (5).

When the conventional pin as shown in FIG. 5 is assembled by inserting the outer threading (65) into the inner threading (52) of the cylindrical body (5) and air is pumped from the path (61) to the path (500), the ball (62) is forced to be positioned at opening (64) by the pumped air. That is, when the pressure of the pumped air is larger than the inner pressure in the container (not shown) to be inflated, the ball (62) is at the opening (64). However, when the pressure inside the container is larger than that of the pumped air, the pressure inside the container pushes the ball (62) backward so as to position the ball (62) at opening (63), which stops leakage of air from the container inflated, as shown in FIGS. 6 and 7.

Although this kind of conventional pin does have the advantages of pumping air into a container to be inflated and preventing air from escaping out of the container, the pin is not able to discharge air out of the container if the pressure inside the container is too great and needs to be released a little.

To overcome the shortcomings, the present invention tends to provide an improved pin to mitigate and obviate the aforementioned problems.

### SUMMARY OF THE INVENTION

The primary objective of the present invention is to provide an improved pin with an air discharging device to allow reduction of pressure inside an over-inflated container.

Other objects, advantages and novel features of the invention will become more apparent from the following detailed description when taken in conjunction with the accompanying drawings.

### BRIEF DESCRIPTION OF THE DRAWINGS

FIG. 1 is a cross sectional view showing the structure of the pin in accordance with the present invention;

FIG. 2 is an end view of the pin in FIG. 1 showing that two elongated bosses are oppositely formed on a peripheral edge of a passage;

FIG. 3 is a schematic cross sectional view showing that air is being pumped to the extension;

FIG. 4 is a schematic cross sectional view showing that air is stopped from leaking by the sphere;

FIG. 5 is an exploded perspective view of a conventional pin with a unidirectional mechanism;

FIG. 6 is a schematic cross sectional view showing that the ball is pushed to one opening when air is pumped to the extension; and

FIG. 7 is a schematic cross sectional view showing that the ball is pushed to the other opening by the pressure from the extension so as to prevent leakage.

### DETAILED DESCRIPTION OF THE PREFERRED EMBODIMENT

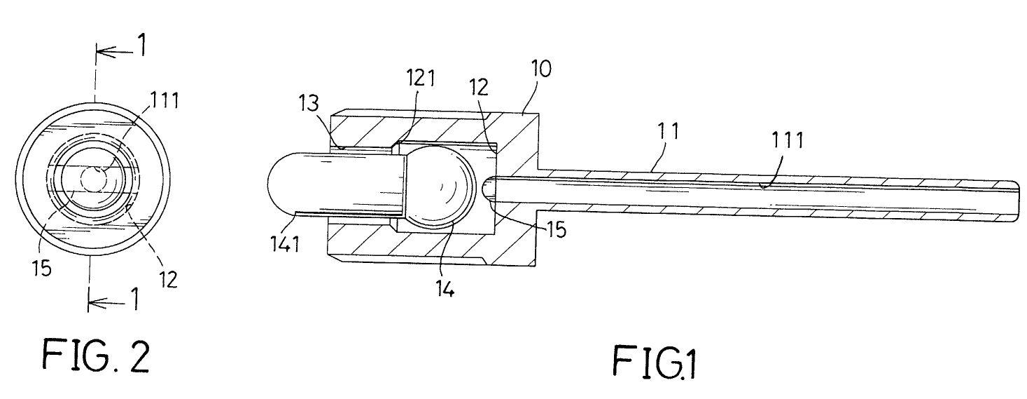

With reference to FIGS. 1 and 2, the pin constructed in accordance with the present invention has a body (10) and an extension (11) formed with the body (10).

The body (10) is hollow and is divided by a step (121) into a chamber (12) and a path (13) communicating with the chamber (12). The step (121) is formed at ajoint of the chamber (12) and the path (13) and the chamber (12) has a diameter larger than that of the path (13). A sphere (14) is received in the chamber (12) and has an activating rod (141) securely formed on the sphere (14) and extending out from the path (13). Two elongated bosses (15) are oppositely formed on a bottom face defining the chamber (12) and apart from each other by a passage (111) in the extension (11).

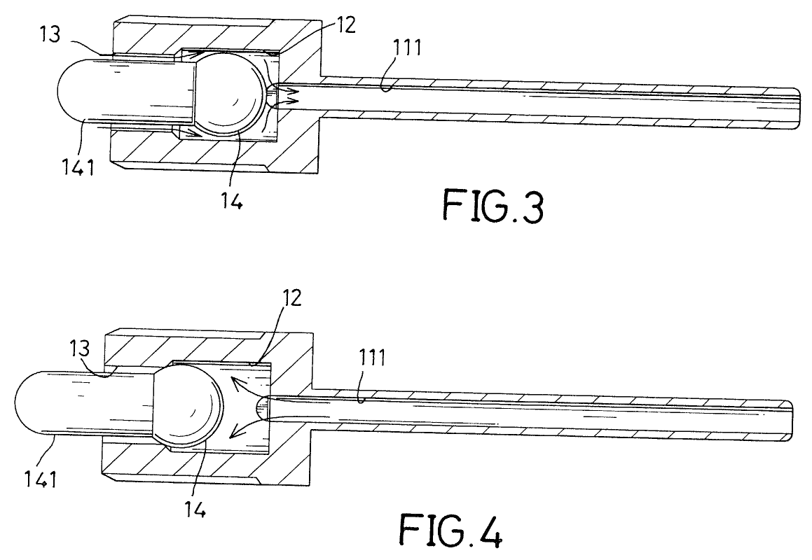

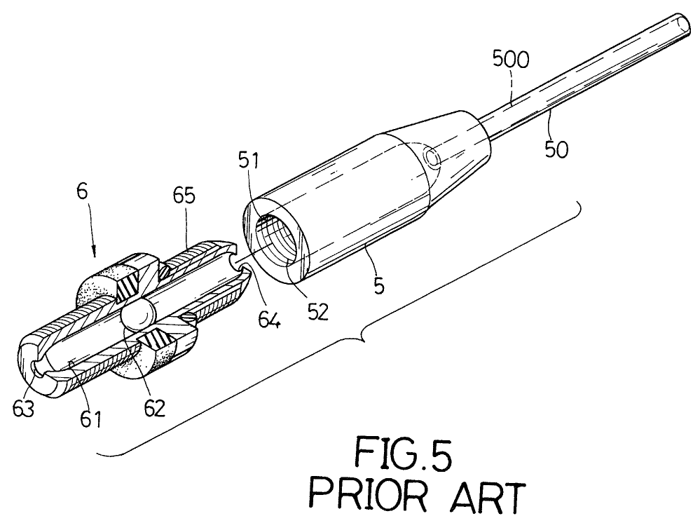

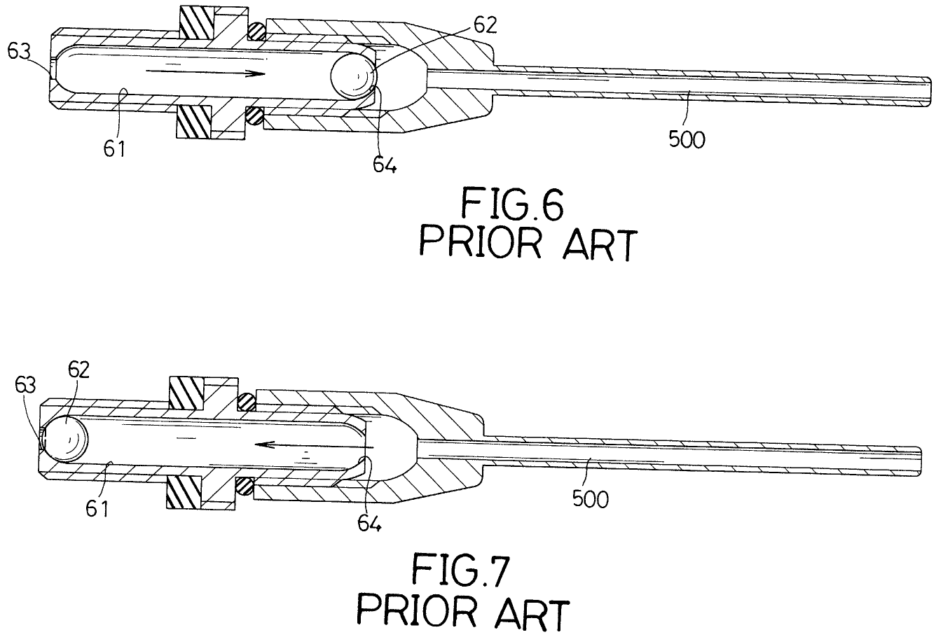

With reference to FIGS. 3 and 4, when air is pumped from the path (13) to the chamber (12), the sphere (14) due to the pressure of the pumped air is pushed to engage with the two elongated bosses (15). A gap remains between the elongated bosses whereby pumped air can travel from the chamber (12) to the passage (111). When the pressure from the passage (111) is larger than the pressure in the path (13), the sphere (14) is pushed by the pressure to engage with the step (121) so as to break the communication between the chamber (12) and the path (13). It is noted that when the user stops pumping air from the path (13) to the chamber (12) and when the pressure in a container (not shown) inflated is larger than the pressure in the path (13), the sphere (14) is pushed to break the communication between the chamber (12) and the path (13). As described in the foregoing description, when the user temporarily stops pumping air into the chamber (12) as well as the passage (111) during a pumping process, the pressure inside the path (13) is smaller than that of the passage (111) so that the sphere (14) is pushed to engage with the step (121) to break the communication between the chamber (12) and the path (13). However, if the pressure in the passage (111) is too large, the user is able to press the activating rod (141) to resume communication between the chamber (12) and the path (13) so as to discharge air from the passage (111), as shown in FIG. 1. When the user feels that the pressure in the passage (111) is appropriate, the user releases the press on the activating rod (141) so that the pressure in the passage (111) pushes the sphere (14) back to engage with the step (121) to again break the communication between the chamber (12) and the path (13).

Therefore, it is to be noted that the pin of the present invention not only has the function of pumping air but also is able to release pressure from an overinflated object.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. In a pin having a hollow body, an extension formed with the hollow body and provided with a passage defined to communicate with an interior of the hollow body and a sphere movably received in the hollow body, wherein the improvements comprise:
the hollow body (10) being divided into a chamber (12) adapted to movably receive therein the sphere (14) and a path (13) by a step (121), the chamber (12) having a diameter larger than that of the path (13) so that the sphere (13) selectively stops communication between the chamber and the path (13),
the chamber (12) having two elongated bosses (15) oppositely formed on a bottom face defining the chamber (12) and being apart from each other by the passage (111), and
an activating rod (141) adapted to be integrally formed on the sphere (14) and extending out of the path (13) so as to move the sphere (14) inside the chamber (12) to resume communication between the path (13) and the chamber (12).
